(19) United States
(12) Patent Application Publication
(10) Pub. No.: US 2014/0101055 A1
(43) Pub. Date: Apr. 10, 2014

(54) SYSTEMS, METHODS, AND COMPUTER PROGRAM PRODUCTS FOR MANAGING REMOTE TRANSACTIONS

(71) Applicant: JVL VENTURES, LLC, New York, NY (US)

(72) Inventors: Terry J. Grissom, Plano, TX (US); Kai P. Johnson, San Diego, CA (US)

(73) Assignee: JVL VENTURES, LLC, New York, NY (US)

(21) Appl. No.: 14/044,391

(22) Filed: Oct. 2, 2013

Related U.S. Application Data
(60) Provisional application No. 61/710,383, filed on Oct. 5, 2012.

(51) Int. Cl. G06Q 20/36

(52) U.S. Cl. CPC G06Q 20/363
USPC 705/71; 705/41

(57) ABSTRACT

Systems, methods, and computer-program products are provided for managing remote transactions. A first request including a wallet identifier (WID) is received from a merchant system. One or more sets of account data, each including an account identifier, are retrieved from at least one memory, based on the WID. A first response including the one or more sets of account data retrieved from the at least one memory are transmitted to the merchant system. An authorization request including an account identifier corresponding to one of the one or more sets of account data retrieved from the at least one memory are received, from either the merchant system or an acquirer system. A transaction data request including the account identifier is transmitted to an issuer system. A transaction data response including transaction data is received from the issuer system and the transaction data is transmitted to the merchant system or the acquirer system.

### CROSS REFERENCE TO RELATED APPLICATION

This application claims priority to U.S. Provisional Patent Application No. 61/710,383, filed Oct. 5, 2012, the entire contents of which are incorporated herein by reference.

### BACKGROUND

1. Field

The present invention relates generally to systems, methods, and computer program products for managing remote transactions.

2. Related Art

Remote transactions refer to the ability to perform transactions without the need to be physically present at a point-of-sale (PoS) and without using PoS hardware. Such transactions can include, for example, payments, money transfers, or distribution or use of vouchers, coupons or loyalty cards. One typical way to perform such transactions remotely is online, via a merchant webpage or mobile application.

A merchant webpage may be an electronic store where goods and services are selected for purchase and added to an electronic shopping cart. A merchant mobile application is an application installed on a mobile device and is configured to function similar to a webpage (e.g., an electronic store), without the need to access it via a web browser. To finalize a purchase, a consumer “checks out” of the electronic store by making a remote payment. To do so, the consumer inputs, into the merchant's webpage, financial instrument (e.g., credit card, debit card) information (e.g., account number, expiration date, account verification code, and the like) used to pay for the goods and/or services, which are, in turn, typically made available for pick up or delivered to the consumer. The account number may be a credit card number or the like associated with a credit account. An account verification code is an identifier associated with an account number, typically referred to as a card verification code (CVC), card verification value code (CVVC), card security code (CSC), etc., and is used as a security feature in addition to an account number.

Another type of transaction is a mobile commerce transaction, which refers to the ability to perform commerce transactions electronically using wireless technology such as mobile devices. One example of a mobile commerce transaction is a purchase of goods in exchange for payment, performed without using physical financial instruments (e.g., credit card, debit card) or cash.

Mobile commerce transactions can be performed using mobile wallets provisioned on a mobile device. A mobile wallet on a mobile device stores payment account information (i.e., credentials associated with a financial instrument). The mobile device equipped with the mobile wallet can be used at a PoS system to perform a mobile commerce transaction by, for example, tapping or scanning the mobile device.

One technical challenge associated with using mobile wallets on mobile devices involves the ability to use mobile wallets for remote transactions, for example, to purchase goods remotely (e.g., online) using payment account information on the mobile wallet. Another technical challenge involves providing merchants with account identifiers, account type, service provider, and user information (e.g., name, address, telephone number) associated with a mobile wallet, from a centralized system. Yet another technical challenge involves securely processing remote transactions using mobile wallets, without providing merchants with sensitive account information (e.g., account number).

### BRIEF DESCRIPTION

The example embodiments presented herein meet the above-identified needs by providing systems, methods, and computer program products for managing remote transactions.

In one embodiment, a system for managing remote transactions, comprises at least one memory operable to store one or more sets of account data, each set of account data including an account identifier; and a processor coupled to the at least one memory. The processor is operable to: receive a first request from a merchant system, the first request including a wallet identifier (WID); retrieve, from the at least one memory, one or more sets of account data based on the WID; transmit, to the merchant system, a first response including the one or more sets of account data retrieved from the at least one memory; receive, from either the merchant system or an acquirer system, an authorization request including an account identifier corresponding to one of the one or more sets of account data retrieved from the at least one memory; transmit, to an issuer system, a transaction data request including the account identifier; receive, from the issuer system, a transaction data response including transaction data; and transmit, to the merchant system or the acquirer system, the transaction data.

In another embodiment, a method for managing remote transactions, comprises steps of: receiving a first request from a merchant system, the first request including a wallet identifier (WID); retrieving, from at least one memory, one or more sets of account data based on the WID; transmitting, to the merchant system, a first response including the one or more sets of account data retrieved from the at least one memory; receiving, from either the merchant system or an acquirer system, an authorization request including an account identifier corresponding to one of the one or more sets of account data retrieved from the at least one memory; transmitting, to an issuer system, a transaction data request including the account identifier; receiving, from the issuer system, a transaction data response including transaction data; and transmitting, to the merchant system or the acquirer system, the transaction data, wherein each of the one or more sets of account data includes an account identifier.

In another embodiment, a non-transitory computer readable-medium has stored thereon sequences of instructions for causing one or more processors to: receive a first request from a merchant system, the first request including a wallet identifier (WID); retrieve, from at least one memory, one or more sets of account data based on the WID; transmit, to the merchant system, a first response including the one or more sets of account data retrieved from the at least one memory; receive, from either the merchant system or an acquirer system, an authorization request including an account identifier corresponding to one of the one or more sets of account data retrieved from the at least one memory; transmit, to an issuer system, a transaction data request including the account identifier; receive, from the issuer system, a transaction data response including transaction data; and transmit, to the merchant system or the acquirer system, the transaction data, wherein each of the one or more sets of account data includes an account identifier.

### BRIEF DESCRIPTION OF THE DRAWINGS

The features and advantages of the example embodiments of the invention presented herein will become more apparent from the detailed description set forth below when taken in conjunction with the following drawings.

FIG. 1 is a diagram of a system for managing remote transactions according to an exemplary embodiment.

FIG. 2 is a diagram of a mobile device for use in remote transactions according to an exemplary embodiment.

FIG. 3 is a sequence diagram for managing a remote transaction according to an exemplary embodiment.

FIG. 4 is a sequence diagram for obtaining transaction data from a secure element via a mobile wallet according to an exemplary embodiment.

FIG. 5 is a sequence diagram for obtaining transaction data from a secure element via a TSM according to an exemplary embodiment.

FIG. 6a is a sequence diagram for providing transaction receipts according to an exemplary embodiment.

FIG. 6b is a sequence diagram for providing transaction receipts according to an exemplary embodiment.

FIG. 7 is a collaboration diagram of functional modules deployed on a computer system in accordance with an example embodiment of the present invention according to an exemplary embodiment.

### DETAILED DESCRIPTION

### I. Overview

The example embodiments presented herein are directed to systems, methods, and computer program products for managing remote transactions, which are described herein in terms of a remote payment. This description is not intended to limit the application of the example embodiments presented herein. In fact, after reading the following description, it will be apparent to one skilled in the relevant art(s) how to implement the following example embodiments in alternative embodiments that can be utilized, for example, to process remote credits, debits, transfers, reservations, ticketing, and the like.

The terms “application,” “applet,” and/or the plural form of these terms are used interchangeably herein to refer to an application (functioning independently or in conjunction with other applications) or set or subset of instructions or code, which when executed by one or more processors (e.g., in a mobile device, merchant system, service provider system, acquirer system) causes the processor(s) to perform specific tasks.

In an exemplary embodiment, a remote transaction is a remote payment made by a user (e.g., consumer) of a client portal in exchange for a purchase of goods from a merchant webpage or mobile application. The client portal, in response to user input, selects goods to purchase using the mechanisms provided by the merchant webpage, for example, the selected goods are grouped into a virtual (i.e., electronic) “shopping cart,” where they can be purchased in exchange for payment. The client portal, in response to user input, can complete the purchase of the goods or “check out,” as this step is commonly called, by selecting a corresponding button or icon on the merchant webpage or mobile application, to begin the payment process.

In response to the request by the user of the client portal to check out, the client portal transmits a request, to the merchant system associated with the merchant webpage or mobile application, for a login page. The merchant system transmits the login page to the client portal, which in turn prompts the user for login credentials (e.g., username and password) for the merchant webpage or mobile application. The user of inputs the login credentials into the client portal, and the login credentials are sent to the merchant system for validation.

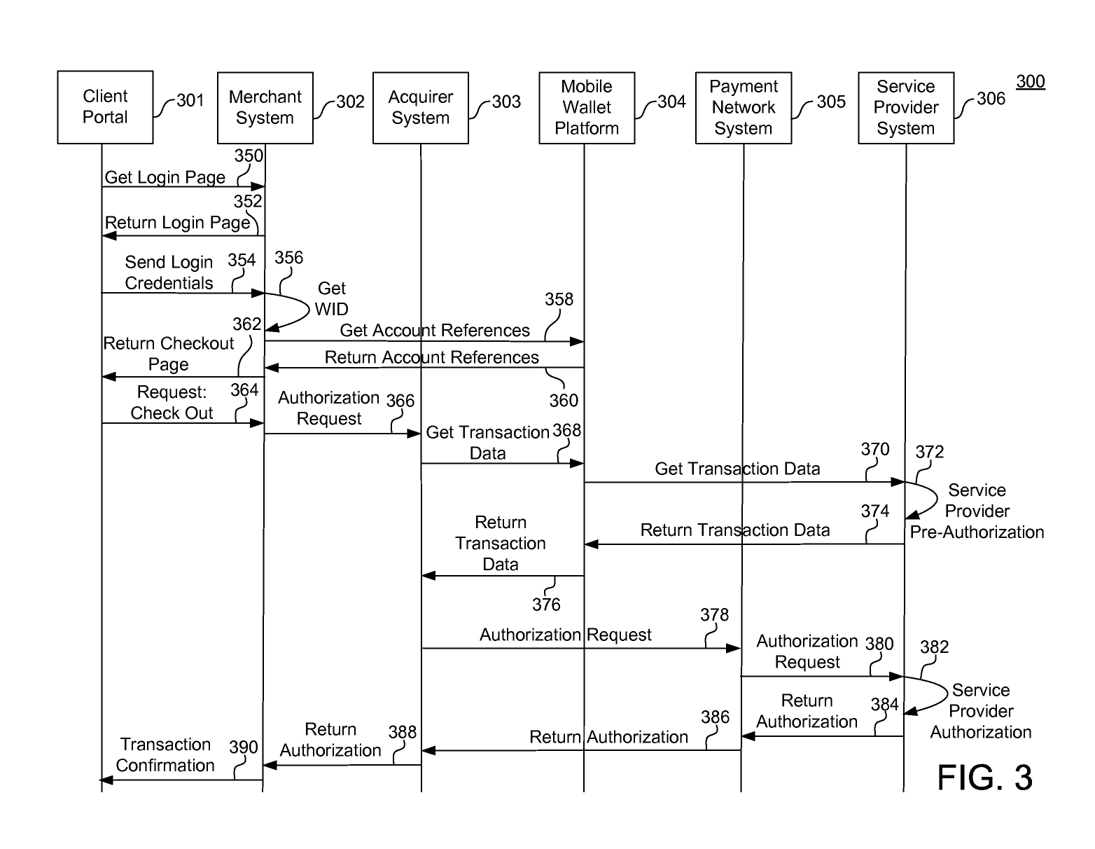

Upon validation, the merchant system retrieves from its storage a wallet identifier (WID) associated with the login credentials. A WID corresponds to a mobile wallet on a mobile device which can be used to make a payment. As described in further detail below with reference to FIG. 3, the WID may be retrieved by the merchant system in multiple ways, including from the storage associated with the merchant system or through “cookies” stored on the web browser of the client portal.

A mobile wallet may have one or more accounts linked (i.e., associated with) to it. Each account linked to a mobile wallet may correspond, for example, to a different financial instrument account, such as a credit card account. Upon receipt of the WID, the merchant system communicates with a mobile wallet platform to obtain one or more sets of account data associated with the WID and its corresponding mobile wallet. The merchant system communicates with the mobile wallet platform to obtain account data and user information (e.g., name, address, telephone) stored on the mobile wallet.

In turn, the merchant system receives the account data and user information and transmits that information to the client portal. The information may be communicated to the client portal, for example, over the merchant webpage or mobile application, where it is displayed and made accessible to the user for example via the interface of the client portal. The client portal selects, in response to user input, from the merchant webpage or mobile application, one of the displayed sets of account data (corresponding to an account on the mobile wallet) to be used to make the payment to purchase the goods. A displayed set of account data may be selected using inputs into the client portal such as mouse clicks or keyboard inputs used to select a check box, button, text, or the like corresponding to an account data set. The client portal sends a check out request to the merchant webpage or mobile application, including at least a portion of the selected set of account data.

The merchant system initiates a request for the service provider associated with the selected account to authorize payment and provide transaction data (e.g., account number, account verification code, account holder name, expiration date) to be used for the payment. This request from the merchant system is sent to an acquirer system, which in turn transmits a request for the transaction data to the mobile wallet platform. The request sent by the acquirer system may include an encryption key (e.g., public encryption key), to be used by the service provider system to encrypt some or all of the transaction data. In this way, the acquirer system, which includes the decryption key (e.g., private decryption key), is the only entity (i.e., system) capable of decrypting the encrypted transaction data. As described in further detail below with reference to FIG. 3, the merchant system can transmit the request for authorization and transaction data directly to the mobile wallet platform, rather than first communicating with the acquirer system.

The mobile wallet platform receives a request for transaction data and obtains the transaction data in one of two ways, which are described in further detail below with reference to FIGS. 3-5. In one exemplary embodiment, the mobile wallet platform transmits the request for transaction data (or a similar request for transaction data) to the service provider system associated with the account selected for payment. The service provider system, in turn, pre-authorizes the transaction based on its own requirements and transmits the transaction data back to the mobile wallet platform. In another exemplary embodiment, the mobile wallet platform retrieves, from the secure element on the mobile device including the mobile wallet, the transaction data. In turn, the mobile wallet platform transmits, to the acquirer system, the transaction data.

If the received transaction data is encrypted, the acquirer system decrypts the transaction data. The acquirer system, in turn, transmits a request including the transaction data to a payment network system to authorize the remote payment transaction. The payment network system transmits the received authorization request (or a similar authorization request) to the service provider system which, in turn, authorizes the transaction. The service provider system transmits a notification of the authorization to the payment network system which, in turn, transmits it to the acquirer system. The acquirer system transmits the notification of authorization to the merchant system, which in turn, transmits a purchase confirmation notification to the client portal.

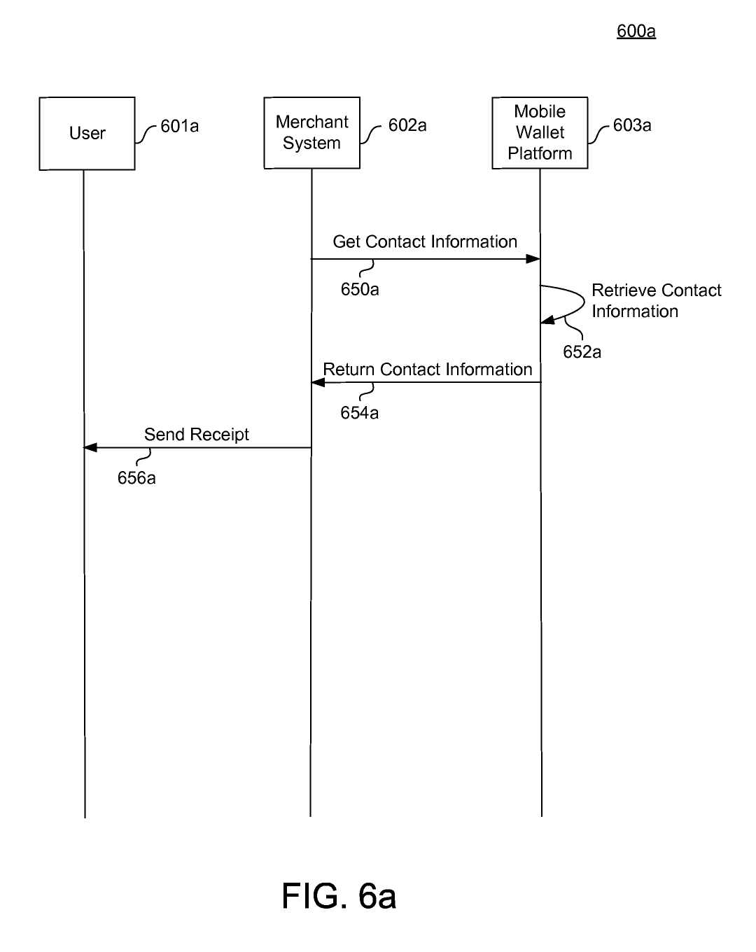

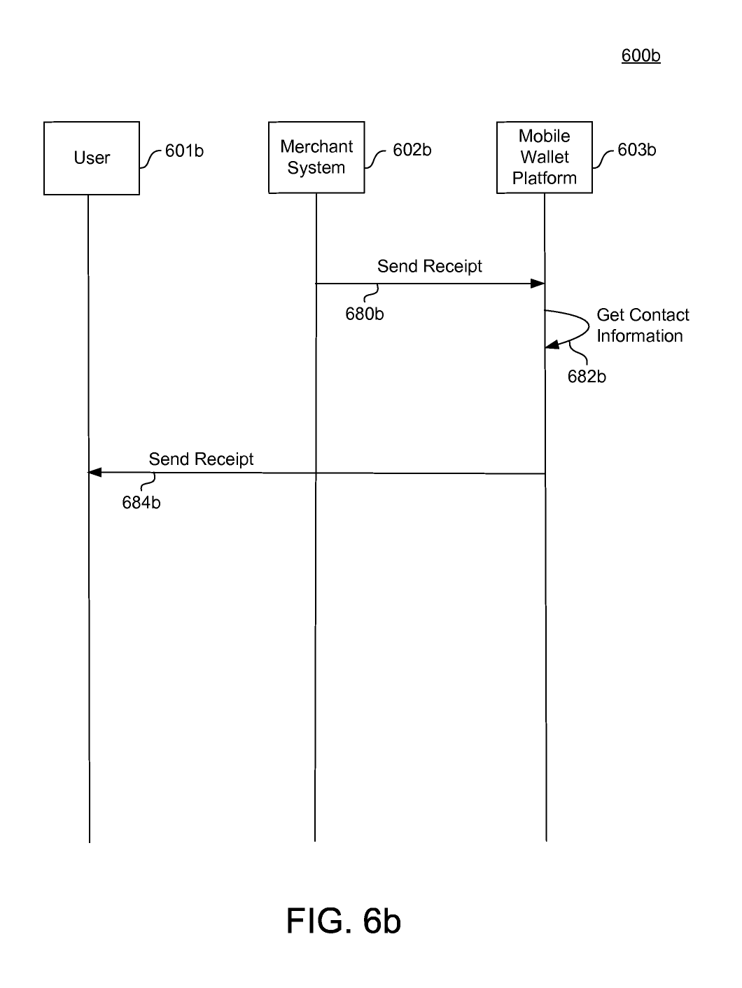

Remote transaction (e.g., remote payment) receipts may be transmitted to the e-mail account of the user of the client portal. As described in further detail below with reference to FIGS. 6a and 6b, transaction receipts may be transmitted in one of two ways. In one exemplary embodiment, the merchant system requests an e-mail address of the user of the client portal from the mobile wallet platform. The mobile wallet platform provides the e-mail address to the merchant system, and the merchant system, in turn, transmits the transaction receipt to the user (i.e., the e-mail address) of the client portal. In another exemplary embodiment, the merchant system transmits the transaction receipt to the mobile wallet platform which, in turn, transmits the transaction receipt to the user (i.e., the e-mail address) of the client portal.

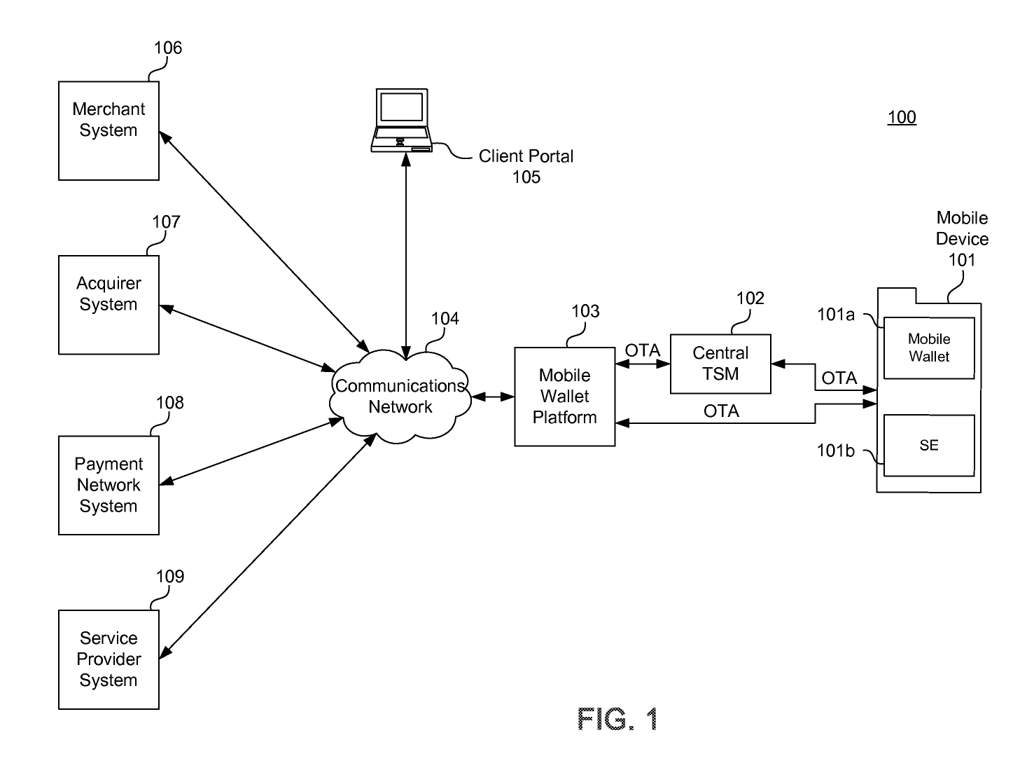

The features discussed above are described in further detail below, with reference to FIGS. 1-7.

### II. System

FIG. 1 depicts a diagram of system 100 for managing remote transactions according to an exemplary embodiment. As shown in FIG. 1, system 100 includes a mobile device 101, central TSM 102 and mobile wallet platform 103. The mobile wallet platform 103 is connected to a communications network 104. Also connected to the communications network 104 is a client portal 105, merchant system 106, acquirer system 107, payment network system 108 and service provider system 109.

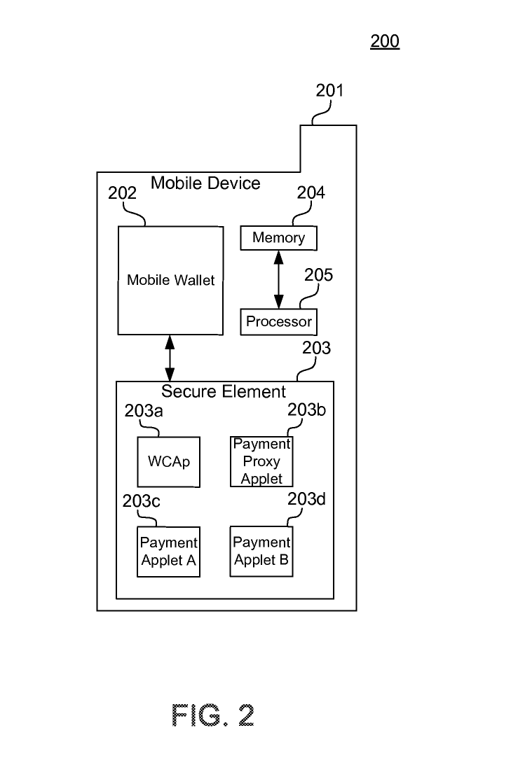

The mobile device 101 may be, for example, a cellular phone, tablet or the like, and includes a mobile wallet 101a and secure element 101b. The secure element 101b may include one or more payment applets and commerce applets. Although one mobile device is illustrated in FIG. 1, it should be understood that multiple mobile devices, including respective mobile wallets and secure elements, may be connected to the central TSM 102. A mobile device (e.g., mobile device 101) is described in further detail below with references to FIG. 2.

The mobile device 101 is communicatively coupled, over-the-air (OTA), to the central TSM 102. “Over-the-air” communication refers to the ability for systems and/or devices to communicate using wireless standards. The central TSM 102 is hardware and/or software that is implemented to serve as an intermediary between entities (e.g., service provider systems, mobile wallet platforms, mobile wallets, secure elements, etc.) in a mobile commerce environment. That is, the central TSM 102 manages communications between entities. For example, in one exemplary embodiment, the central TSM manages communications between a mobile wallet platform and a secure element, in order to request and obtain transaction data for use in a remote transaction.

The mobile device 101 and the central TSM 102 are communicatively coupled, OTA, to the mobile wallet platform 103. The mobile wallet platform 103 includes a processor and at least one storage means (e.g., memory) for storing sets of account data associated with mobile wallets. The mobile wallet platform 103 is configured to communicate with multiple systems and/or devices to process a remote transaction. In one exemplary embodiment, the mobile wallet platform receives and processes requests for account data and transaction data.

The mobile wallet platform 103 is communicatively coupled to the client portal 105, merchant system 106, acquirer system 107, payment network system 108 and service provider system 109 over the communications network 104. The communications network 104 may be a virtual private network (VPN), a network using Hypertext Transfer Protocol (HTTP) standards, the Internet, or the like.

The client portal 105 may be any system such as a laptop, personal computer, mobile device, tablet, workstation or the like, capable of accessing the Internet, for example, to perform remote transactions.

The merchant system 106 is a system managed by a merchant, for example, for processing remote transactions. A merchant may be a retailer, business, or the like. The merchant system 106 includes and/or manages a webpage or mobile application associated with the merchant. The merchant webpage or mobile application may include an online store, which allows consumers to electronically perform commerce transactions such as purchases, payments, credits, debits, transfers, etc. For example, an online store can be used to purchase and pay for goods or services offered by the merchant.

The acquirer system 107 is a system managed by an acquirer (or acquiring bank), for example, for processing remote transactions including remote payments. An acquirer is a bank or financial institution that processes transactions such as payments for goods or services, on behalf of a merchant. In one exemplary embodiment, an acquirer system communicates with service provider (e.g., issuer) systems to exchange funds on behalf of a merchant during the processing of a remote transaction.

The payment network system 108 is a system managed by a payment network. A payment network is a network of systems linking financial institutions for the exchange of monetary value (e.g., money) during a transaction such as a remote payment. In one exemplary embodiment, a payment network system processes an exchange of money between an acquirer and a service provider, to pay for goods purchased during a remote transaction.

The service provider system 109 is a system managed by a service provider. A service provider may be an issuer, issuing bank or the like that offers financial instruments such as credit cards and debit cards for use by consumers in transactions. In one exemplary embodiment, the service provider system authorizes transactions such as remote payments, on behalf of a consumer. That is, the service provider system receives a request to pre-authorize and authorize a remote payment for a purchase of goods made by a consumer. The service provider system, in turn, determines whether to pay for those goods on behalf of the consumer, using a line of credit extended by the service provider to the consumer.

Each of the central TSM 102, mobile wallet platform 103, client portal 105, merchant system 106, acquirer system 107, payment network system 108 and service provider system 109 include, at least, a processor and one or more storage means (e.g., memory). Although one client portal, merchant system, acquirer system, payment network system and service provider system are illustrated in FIG. 1, it should be understood that multiple such systems can exist and participate in processing a remote transaction such as a remote payment.

FIG. 2 depicts a diagram of mobile device 200 for use in remote transactions according to an exemplary embodiment. As shown in FIG. 2, mobile device 201 (e.g., FIG. 1, mobile device 101) includes a mobile wallet 202 (e.g., FIG. 1, mobile wallet 101a), secure element 203 (e.g., FIG. 1, secure element 101b), memory 204 and processor 205. Although not illustrated in FIG. 2, the mobile device 201 may include a contactless frontend (CLF), a baseband modem, and a user interface such as a display. A baseband modem is a digital modem that is used for wireless communications. A CLF is circuitry which handles the analog aspect of contactless or NFC communications and the communication protocol layers of a contactless transmission link.

The mobile wallet 202 (i.e., mobile wallet application) includes instructions which, when executed by the processor 205 of the mobile device 201, cause the mobile device to act as an instrument, for example, for processing transactions such as remote transactions (e.g., remote payments). The mobile wallet 202 provides an interface for receiving inputs and displaying outputs. The mobile wallet 202 communicates with the secure element 202 and applets stored on the secure element, using commands transmitted via application programming interfaces (APIs) (not illustrated).

The secure element 203 may be implemented as a Universal Integrated Circuit Card (UICC), embedded SE card, secure micro secure digital (microSD) card, and the like. A secure element (e.g., secure element 203) is generally considered secure because it is a self-contained system, including dedicated memory, and is protected by hardware and software hardening techniques that are verified by independent testing. The secure element 203 includes (i.e., has stored thereon) a wallet companion applet (WCAp) 203a, a payment proxy applet 203b, a payment applet A 203c, and a payment applet B 203d. Although not illustrated in FIG. 2, the secure element 203 may also include a commerce applet, capable of operating as a storage container and interface for offer data management, and may be used to redeem an offer during a remote transaction.

The mobile wallet 202 communicates with payment applets (e.g., payment applet A 203c and payment applet B 203d) on the secure element 203 to process remote transactions such as remote payments. A payment applet corresponds to a service provider, and is used to make payments using a mobile wallet. A payment applet stores sensitive service provider data, such as transaction data (e.g., account number, account verification code, account holder name, expiration date) associated with a service provider account issued to a consumer. Examples of payment applets include ExpressPay from American Express®, Discover® Network Zip^{SM}, MasterCard® PayPass™ and Visa payWave™. In one exemplary embodiment, a mobile wallet transmits a request to a secure element, to retrieve and provide transaction data from a payment applet, for processing a remote payment. Although only two payment applets (e.g., payment applet A 203c and payment applet B 203d) are illustrated in FIG. 2, it should be understood that any number of payment applets may be stored on a secure element and used to process a remote transaction.

The secure element 203 also includes the WCAp 203a, which is used to manage and secure applets (e.g., payment applet A 203c and payment applet B 203d) stored in the secure element. The WCAp 203a performs functions such as: storing mobile wallet data, authenticating passcodes, managing applet data and managing the state (e.g., activate, deactivate) of applets on the secure element. In one exemplary embodiment, a WCAp processes a request from a mobile wallet to retrieve transaction data from a payment applet on the secure element.

The payment proxy applet 203b is an applet stored on the secure element 203, and is used to communicate with payment applets on the secure element. The payment proxy applet 203 is well secured using hardening techniques, so as to reliably transmit information. In one exemplary embodiment, a payment proxy applet processes a request from a central TSM to retrieve transaction data from a payment applet on a secure element.

### III. Process

### A. Managing a Remote Transaction

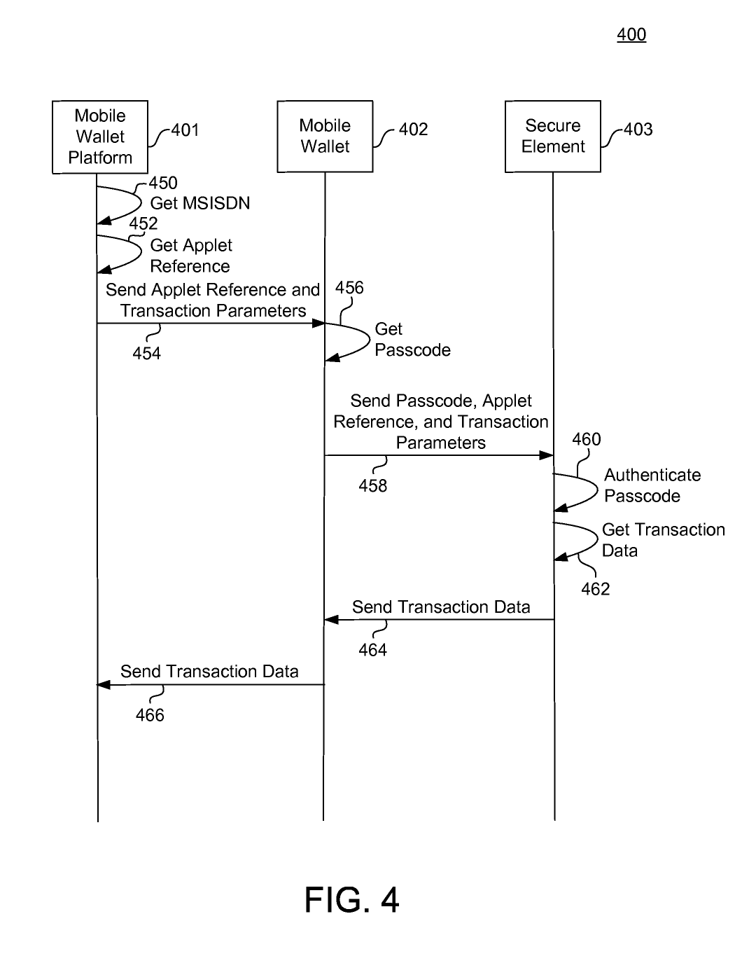

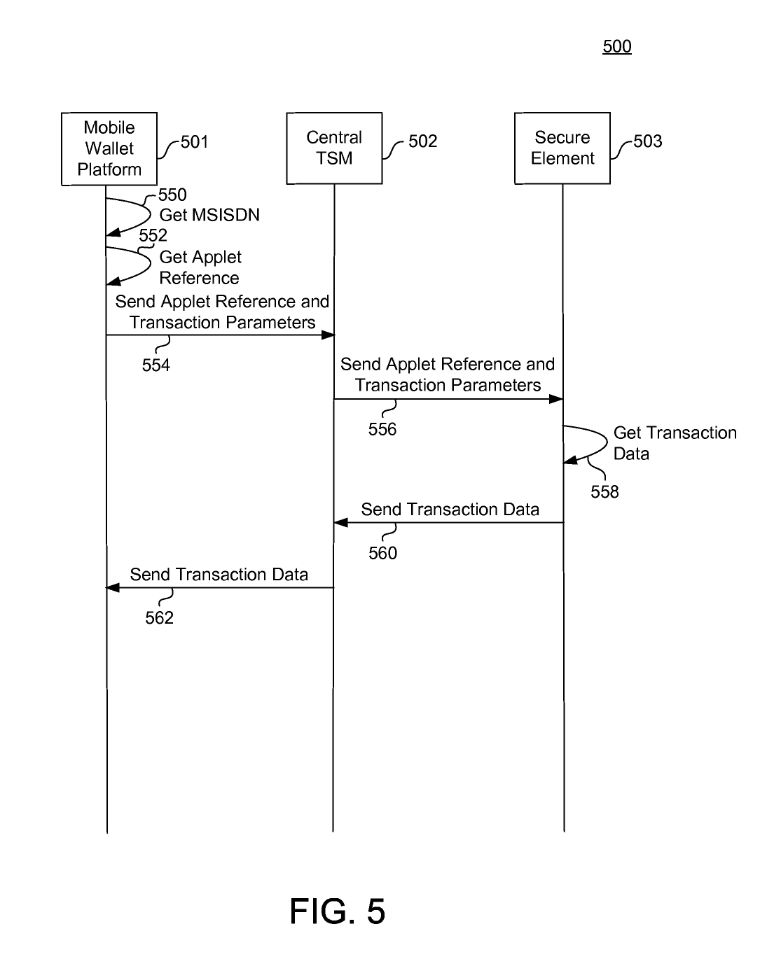

FIG. 3 depicts a sequence diagram 300 for managing a remote transaction according to an exemplary embodiment. In the exemplary embodiment illustrated in FIG. 3, transaction data and a pre-authorization are obtained from a service provider system. In alternative embodiments described in further detail below with reference to FIGS. 4 and 5, transaction data is obtained from a secure element.

In FIG. 3, a client portal 301 (e.g., FIG. 1, client portal 105) is operated by a user and/or consumer performing a remote transaction using a merchant's webpage or mobile application. Specifically, in FIG. 3, the remote transaction is a purchase of goods by a user operating the client portal 301. The client portal 301, in response to user input, performs a “check out” to finalize the transaction and pay for the purchased goods. Traditionally, merchant webpages or mobile application allow client terminals operated by users to add items (e.g., goods) to a virtual shopping cart and subsequently “check out” by paying for the items in the virtual shopping cart.

At step 350, the client portal 301 transmits a request to obtain a login page (Get Login Page) to a merchant system 302 (e.g., FIG. 1, merchant system 106) associated with a merchant, in order to perform a check out. The request to obtain a login page may be transmitted by the client portal 301 in response to a selection of an icon (e.g., “log in,” “check out”), button or the like on the merchant's webpage or mobile application, by the user of the client portal 301. The merchant's webpage or mobile application is managed by the merchant system 302 or a separate merchant system communicatively coupled to the merchant system 302.

The merchant system 302 receives the request (Get Login Page) from the client portal 301 and transmits a login page (Return Login Page) to the client portal 301, at step 352. A login page may be a webpage or mobile application, short message service (SMS), or any similar message or prompt for login credentials to be used by the merchant system 302 to authenticate a user. Login credentials may be any information requested by the merchant system 302 to authenticate a user, and typically includes a username and password combination.

The client portal 301 receives the login page transmitted by the merchant system 302 and presents it (i.e., prompts) to the user of the client portal 301. This is done, for example, by displaying the login page on a display of the client portal. In turn, the user inputs login credentials (e.g., username and password combination) as requested by the merchant system 302 into the login page via the client portal 301. The input of data can be done using any device (e.g., keyboard, mouse) included in or attached to the client portal. The client portal 301 transmits the login credentials to the merchant system 302, at step 354.

Although not illustrated in FIG. 3, upon receipt of the login credentials, the merchant system 302 determines whether the received login credentials are valid (e.g., the received set of credentials matches a set of credentials stored in the merchant system 302). If the merchant system 302 determines that the received login credentials are valid, the merchant system 302 may transmit a notification to the client portal 301 indicating that the login credentials were successfully validated. Alternatively, if the merchant system 302 determines that the received login credentials are not valid, the merchant system 302 may transmit a notification to the client portal 301 (1) indicating that validation of the received login credentials was unsuccessful, and/or (2) re-prompt the client portal for login credentials.

If the merchant system 302 determines that the login credentials are valid, the merchant system 302 retrieves a wallet identifier (WID) (Get WID) associated with the login credentials, at step 356. A WID is a unique identifier associated with a mobile wallet. A WID may be retrieved by the merchant system 302 in several ways. In one exemplary embodiment, the merchant system 302 may retrieve from its storage a WID associated with the received login credentials. The WID and login credentials may have been associated and stored by the merchant system 302 during a prior processing of a remote transaction. In an alternative exemplary embodiment, a WID associated with the received login credentials may be retrieved by the merchant system 302 from “cookies” stored on the client portal 301. As explained above, “cookies” are data stored in a computer and/or client portal including information (e.g., user activity, login credentials) associated with previous users of the computer and/or client portal.

At step 358, the merchant system 302 transmits a request (Get Account References), to a mobile wallet platform 304 (e.g., FIG. 1, mobile wallet platform 103), to obtain one or more sets of account data (“account data set”) associated with the WID transmitted in the request. That is, the merchant system 302 makes a request to obtain information associated with accounts linked to the WID. An account data set includes information associated with an account, such as an image (e.g., image of a card associated with the account), last four digits of the account number, account nickname, an account ID and the like, but need not include the account number associated with the account. The account ID is a unique identifier associated with an account, and is used to identify an account without the need to transmit and/or share the account number associated with the account. The account ID is “opaque,” meaning that it can be dynamically generated for each merchant system and/or for each remote transaction. For example, an account ID associated with an account and provided by the mobile wallet platform may vary from when it is provided to one merchant system as to when it is provided to another merchant system. In this way, a merchant system can participate in a remote transaction without accessing and/or handling sensitive information such as account numbers. Further, the number of communications of account numbers, and thereby the number of systems and/or devices being privy to account numbers, can be minimized.

In turn, the mobile wallet platform 304 retrieves (e.g., by querying), from its storage, the account data set associated with the WID included in the request (Get Account References) transmitted at step 358. At step 360, the mobile wallet platform 304 transmits (Return Account References) the retrieved account data set to the merchant system 302.

At step 362, the merchant system 302 transmits (Return Checkout Page) the WID and account data sets received at step 360 to the client portal 301. The merchant system 302 may also transmit, at step 362, in addition to the account data, user information associated with the WID (e.g., name, address, telephone, etc.). The account data sets, WID and user information associated with the WID are transmitted to the client portal 301, for example, via the merchant's webpage or mobile application. That is, the account data sets, WID and user information associated with the WID may be transmitted to the client portal 301 in the form of a checkout webpage or mobile application, which displays at the client portal, the received account data sets (e.g., account ID). In this way, remote transactions can be made more efficient.

In turn, the client portal 301 selects, in response to user input, via the checkout webpage or mobile application, an account to be used to make a payment for the purchased goods. The account is selected from one of the accounts associated with the account data sets displayed at the checkout webpage or mobile application. The client portal 301 transmits to the merchant system 302 a request to check out (Request: Check Out), at step 364. The request to check out (Request: Check Out) includes at least a portion of the account data set (e.g., account ID) associated with the selected account and the WID.

The merchant system 302 receives the request to check out (Request: Check Out) and transmits an authorization request (Authorization Request) to an acquirer system 303 (e.g., FIG. 1, acquirer system 107), at step 366. The authorization request (Authorization Request) includes account data, including the account ID, received from the merchant system in the request to check out (Request: Check Out), and the WID. The authorization request (Authorization Request) may also include transaction parameters, which is information associated with a transaction, such as merchant data (e.g., merchant ID, merchant name), transaction goods, transaction balance and the like.

In turn, at step 368, the acquirer system 303 transmits, to the mobile wallet platform 304, a request to obtain transaction data (Get Transaction Data). Transaction data includes information used to process a transaction, such as an account number, account verification code, account holder name, and/or expiration date associated with an account. The request to obtain transaction data (Get Transaction Data) includes (1) account data including account ID received from the merchant system 302, (2) the WID, (3) the transaction parameters received from the merchant system 302, and/or (4) an encryption key, which can be used by a system (e.g., service provider system) to encrypt data (e.g., account number).

At step 370, the mobile wallet platform 304 transmits a request to obtain transaction data (Get Transaction Data) to a service provider system 306 (e.g., FIG. 1, service provider system 109). The request to obtain transaction data (Get Transaction Data) transmitted by the mobile wallet platform 304 to the service provider system 306 is similar to the request to obtain transaction data transmitted by the acquirer system 303 at step 368. That is, the request to obtain transaction data transmitted at step 370 is based on the information received in the request to obtain transaction data (Get Transaction Data) transmitted at step 368. For example, the request (Get Transaction Data) transmitted at step 370 includes account data (e.g., account ID), transaction parameters and/or an encryption key.

In alternative embodiments described in further detail below with reference to FIGS. 4 and 5, the mobile wallet platform 304 retrieves transaction data from a secure element, without requesting the transaction data from the service provider system 306.

As further illustrated in FIG. 3, the service provider system 306 receives the request (Get Transaction Data) and performs a pre-authorization (Service Provider Pre-Authorization) of a transaction, at step 372, based on the received data. A pre-authorization is based on predetermined requirements established by each service provider. For example, a service provider pre-authorization may include validating the received account data and transaction parameters, and retrieving (e.g., by querying from its storage) transaction data (e.g., account number, account verification code) associated with the received account data. An account verification code may be a static identifier associated with an account, or a dynamic identifier that is uniquely generated for each transaction.

If the service provider system 306 successfully pre-authorizes the transaction at step 372, the service provider system 306 encrypts at least a portion of the retrieved transaction data, such as the account number, using the encryption key received at step 370. In an alternative embodiment, the service provider system 306 does not encrypt the transaction data. At step 374, the service provider transmits, to the mobile wallet platform 304, the transaction data (Return Transaction Data), including the encrypted account number and/or account verification code.

In turn, at step 376, the mobile wallet platform 304 transmits the transaction data (Return Transaction Data) to the acquirer system 303, based on the information received by the mobile wallet platform 304 at step 374.

The acquirer system 303, in turn, processes the transaction in accordance with steps 378-390 in FIG. 3. If the account number in the transaction data received by the acquirer system 303 at step 376 is encrypted, the acquirer system decrypts the account number using the encryption key, which the acquirer system previously transmitted to the mobile wallet platform at step 368.

At step 378, the acquirer system transmits an authorization request (Authorization Request) to a payment network system 305 (e.g., FIG. 1, payment network system 108). The authorization request includes at least part of the transaction data received by the acquirer system at step 303. The payment network system 305, at step 380, transmits an authorization request (Authorization Request) to the service provider system 306 based on the information (e.g., transaction data) received from the acquirer system 303 at step 378.

The service provider system 306 determines whether to authorize the transaction (Service Provider Authorization), at step 382, based on the information received from the payment network system 305. Each service provider associated with a service provider system (e.g., service provider system 306) authorizes transactions based on its own predetermined rules. If the service provider system 306 does not authorize the transaction, the service provider system 306 may transmit a notification to the payment network system 305 indicating that the transaction was not successfully authorized and/or the reasons for the failed authorization.

Alternatively, if the transaction is authorized at step 382, the service provider system 306 transmits, at step 384, an authorization (Return Authorization) to the payment network system 305. The authorization (Return Authorization) may include a notification (and/or reasons) that the transaction authorization request initiated by the acquirer system 303 at step 378 was successful. In turn, the payment network system 305 transmits an authorization (Return Authorization) to the acquirer system 303, at step 386, based on the information in the authorization received from the service provider system 306. Similarly, the acquirer system 303 transmits an authorization (Return Authorization) to the merchant system 302, at step 388, based on the information in the authorization received from the payment network system 305. At step 390, the merchant system transmits a confirmation (Transaction Confirmation) to the client portal 301, including information indicating that the transaction initiated by the client portal 301 was authorized and successfully processed.

In alternative embodiments described in further detail below with reference to FIGS. 6a and 6b, the merchant system 302 provides a transaction receipt to a user of a client portal having performed a transaction (e.g., the user of client portal 301).

In an alternative embodiment, the mobile wallet platform 304 obtains pre-authorization from a mobile wallet. The mobile wallet pre-authorization can be performed by itself or in addition to the service provider pre-authorization of step 372. The mobile wallet pre-authorization can be performed before or after the service provider pre-authorization of step 372. In a mobile wallet pre-authorization, the mobile wallet platform 304 transmits account data and transaction parameters (e.g., merchant name, transaction balance) to a mobile wallet associated with a WID associated with a transaction. The mobile wallet, which is stored on a mobile device, displays account data and transaction parameters and prompts the user of the mobile device to verify that the information is valid and accurate. The account data and transaction parameters are displayed, for example, via the interface or screen of the mobile device. The mobile wallet also prompts the user of the mobile device to input a passcode to pre-authorize the transaction. In turn, the mobile wallet receives the input passcode and validates it by comparing the input passcode to a previously stored passcode associated with the mobile wallet. If the account data, transaction parameters and passcode are validated, the mobile wallet informs the mobile wallet platform that the transaction has been pre-authorized. The mobile wallet platform can proceed with processing of the transaction.

In an alternative embodiment, a user may login (i.e., input credentials into a login page) prior to selecting goods for purchase from a merchant webpage or mobile application, rather than at the time of checking out when goods have been selected for purchase.

In an alternative embodiment, a merchant system may request sets of account data associated with a WID at any time after obtaining login credentials. For example, the merchant system may request, from a mobile wallet platform, sets of account data immediately after a user login or after the user requests to check out.

### B. Obtaining Transaction Data from a Secure Element

FIG. 4 depicts a sequence diagram 400 for obtaining transaction data from a secure element via a mobile wallet.

In FIG. 4, a mobile wallet platform 401 (e.g., FIG. 1, mobile wallet platform 103) obtains transaction data based on information received from a merchant system (e.g., in FIG. 3, step 368), such as account data (e.g., account ID), transaction parameters and WID. At step 450, the mobile wallet platform 401 retrieves a mobile subscriber integrated services digital network-number (MSISDN) (Get MSISDN), from its storage. A MSISDN is typically a MSISDN associated with a mobile wallet and WID. The MSISDN is the unique telephone or contact number associated with a mobile device on which a mobile wallet associated with the WID is stored.

At step 452, the mobile wallet platform 401 retrieves (Get Applet Reference), from its storage, applet data (e.g., applet ID) associated with the account ID. The applet data includes information associated with an applet, such as a payment applet (e.g., FIG. 2, payment applet A 203c) stored on a secure element (e.g., FIG. 2, secure element 203), which is to be used to process the transaction.

In turn, the mobile wallet platform 401 contacts, using the retrieved MSISDN, a mobile wallet 402 (e.g., FIG. 2, mobile wallet 202) stored on the mobile device (not shown in FIG. 4) (e.g., FIG. 2, mobile device 201) associated with the MSISDN. In particular, the mobile wallet platform 401 transmits (Send Applet Reference and Transaction Parameters), at step 454, the received transaction parameters and the retrieved applet data to the mobile wallet 402.

At step 456, the mobile wallet 402 retrieves a passcode (Get Passcode). For example, the mobile wallet 402 may display a prompt via the interface of the mobile device requesting input of a passcode to be used to approve a transaction. The user of the mobile device inputs a passcode using the screen and/or keys of the mobile device.

The mobile wallet 402 transmits to a WCAp on a secure element 403 (Send Passcode, Applet Reference and Transaction Parameters), at step 458, the received (i.e., input) passcode, applet data, and transaction parameters. At step 460, the WCAp on the secure element 403 authenticates the passcode, for example, by verifying that the received passcode matches a previously stored passcode associated with the mobile wallet 402.

At step 462, the WCAp on the secure element 403 retrieves (Get Transaction Data) transaction data from the applet associated with the received applet data. That is, the WCAp communicates with an applet on the secure element 403 corresponding to the received applet data (e.g., applet ID), and obtains the transaction data (e.g., account number, account verification code) associated with that applet.

In turn, at step 464, the WCAp on the secure element 403 transmits (Send Transaction Data) the retrieved transaction data to the mobile wallet 402. At step 466, the mobile wallet 402 returns (Send Transaction Data) the transaction data received from the secure element 403 to the mobile wallet platform 401. The mobile wallet platform 401 receives the transaction data and can continue performing the transaction, for example, by forwarding the transaction data to an acquirer system for processing.

FIG. 5 depicts a sequence diagram 500 for obtaining transaction data from a secure element via a TSM.

In FIG. 5, a mobile wallet platform 501 (e.g., FIG. 1, mobile wallet platform 103) obtains transaction data based on information received from a merchant system (e.g., in FIG. 3, step 368), such as account data (e.g., account ID), transaction parameters and WID. At step 550, the mobile wallet platform 501 retrieves (Get MSISDN), from its storage, a MSISDN associated with the WID. As discussed above, the MSISDN is the unique telephone or contact number associated with a mobile device on which a mobile wallet associated with the WID is stored.

At step 552, the mobile wallet platform 501 retrieves (Get Applet Reference), from its storage, applet data (e.g., applet ID) associated with the account ID. The applet data includes information associated with an applet, such as a payment applet (e.g., FIG. 2, payment applet A 203c), stored on a secure element (e.g., FIG. 2, secure element 202), which is to be used to process the transaction.

In turn, the mobile wallet platform 501 transmits (Send Applet Reference and Transaction Parameters) information to a central TSM 502 (e.g., FIG. 1, central TSM 102). In particular, the mobile wallet platform 501 transmits, at step 554, the received transaction parameters and the retrieved applet data to the TSM 502.

At step 556, the central TSM 502 transmits to a payment proxy applet (e.g., FIG. 2, payment proxy applet 203b) on a secure element 503 (Send Applet Reference and Transaction Parameters) the received applet data and transaction parameters. At step 558, the payment proxy applet on the secure element 503 retrieves (Get Transaction Data) transaction data from the applet associated with the received applet data. That is, the payment proxy applet communicates with an applet on the secure element 503 corresponding to the received applet data (e.g., applet ID), and obtains the transaction data (e.g., account number, account verification code) associated with that applet.

In turn, at step 560, the payment proxy applet on the secure element 503 transmits (Send Transaction Data) the retrieved transaction data to the TSM 502. At step 566, the TSM 502 returns (Send Transaction Data) the transaction data received from the secure element 503 to the mobile wallet platform 501. The mobile wallet platform 501 receives the transaction data and can continue performing the transaction, for example, by forwarding the transaction data to an acquirer system for processing.

### C. Providing Transaction Receipts

FIGS. 6a and 6b depict sequence diagrams 600a and 600b for providing transaction receipts.

In FIG. 6a, a receipt is provided to a user (e.g., consumer) 601a. The receipt may be transmitted to a user, for example, via e-mail, SMS, or the like, using contact information associated with the user. The user 601a is associated with a mobile wallet (e.g., FIG. 1, mobile wallet 101a) used to perform a transaction initiated from a client portal (e.g., FIG. 1, client portal 105). At step 650a, a merchant system 602a (e.g., FIG. 1, merchant system 106) transmits a request (Get Contact Information) for contact information (e.g., e-mail address MSISDN) of the user 601, to a mobile wallet platform 603a (e.g., FIG. 1, mobile wallet platform 103). The request (Get Contact Information) includes the WID associated with a processed transaction. The mobile wallet platform 603a retrieves (Retrieve Contact Information) from its storage, at step 652a, contact information associated with the received WID.

In turn, at step 654a, the mobile wallet platform 603a transmits the retrieved contact information (Return Contact Information) to the merchant system 602a. The merchant system 602a uses the received contact information to transmit (Send Receipt), at step 656a, a receipt to the user 601a, for example, at an e-mail address or MSISDN included in the contact information. The receipt includes receipt data of a processed transaction, including items, cost, balance, shipping information, and/or the like.

In FIG. 6b, a receipt is provided to a user (e.g., consumer) 601b. The receipt may be transmitted to a user, for example, via e-mail, SMS or the like. At step 680b, the merchant system 602b transmits (Send Contact Information) a receipt including receipt data of a processed transaction to the mobile wallet platform 603b. The receipt may also include a WID associated with the transaction. The mobile wallet platform 603b retrieves (Retrieve Contact Information) from its storage, at step 682b, the contact information associated with the received WID. In turn, the mobile wallet platform 603b uses the retrieved contact information and transmits (Send Receipt) a receipt, including receipt data of the processed transaction, to the user 601b, at step 684b.

### IV. Computer Readable Medium Implementation

The example embodiments described above such as, for example, the systems and procedures depicted in or discussed in connection with FIGS. 1-6b or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

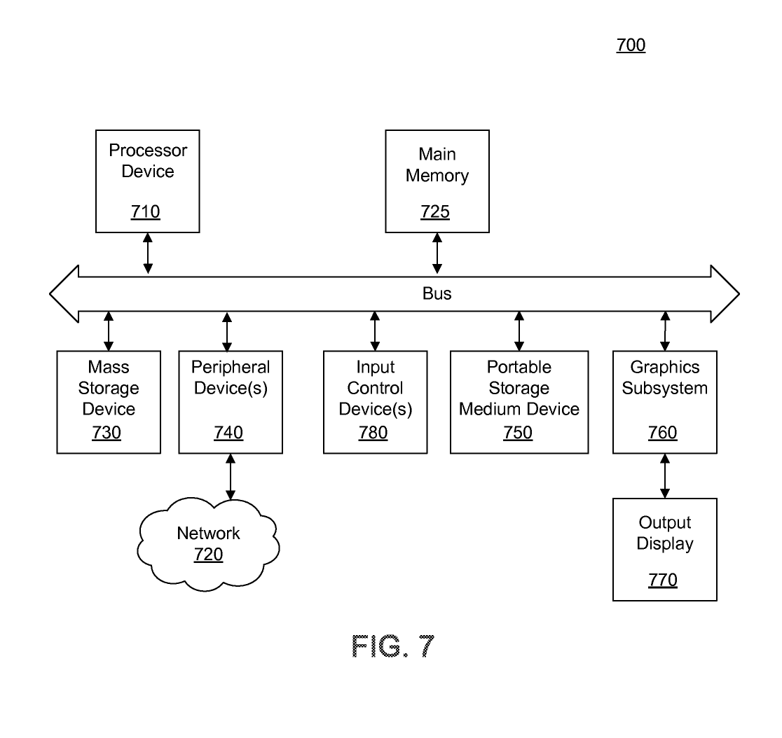

FIG. 7 is a block diagram of a general and/or special purpose computer 700, in accordance with some of the example embodiments of the invention. The computer 700 may be, for example, a user device, a user computer, a client computer and/or a server computer, among other things.

The computer 700 may include without limitation a processor device 710, a main memory 725, and an interconnect bus 705. The processor device 710 may include without limitation a single microprocessor, or may include a plurality of microprocessors for configuring the computer 700 as a multi-processor system. The main memory 725 stores, among other things, instructions and/or data for execution by the processor device 710. The main memory 725 may include banks of dynamic random access memory (DRAM), as well as cache memory.

The computer 700 may further include a mass storage device 730, peripheral device(s) 740, portable storage medium device(s) 750, input control device(s) 780, a graphics subsystem 760, and/or an output display 770. For explanatory purposes, all components in the computer 700 are shown in FIG. 7 as being coupled via the bus 705. However, the computer 700 is not so limited. Devices of the computer 700 may be coupled via one or more data transport means. For example, the processor device 710 and/or the main memory 725 may be coupled via a local microprocessor bus. The mass storage device 730, peripheral device(s) 740, portable storage medium device(s) 750, and/or graphics subsystem 760 may be coupled via one or more input/output (I/O) buses. The mass storage device 730 may be a nonvolatile storage device for storing data and/or instructions for use by the processor device 710. The mass storage device 730 may be implemented, for example, with a magnetic disk drive or an optical disk drive. In a software embodiment, the mass storage device 730 is configured for loading contents of the mass storage device 730 into the main memory 725.

The portable storage medium device 750 operates in conjunction with a nonvolatile portable storage medium, such as, for example, a compact disc read only memory (CD-ROM), to input and output data and code to and from the computer 700. In some embodiments, the software for storing an internal identifier in metadata may be stored on a portable storage medium, and may be inputted into the computer 700 via the portable storage medium device 750. The peripheral device(s) 740 may include any type of computer support device, such as, for example, an input/output (I/O) interface configured to add additional functionality to the computer 700. For example, the peripheral device(s) 740 may include a network interface card for interfacing the computer 700 with a network 720.

The input control device(s) 780 provide a portion of the user interface for a user of the computer 700. The input control device(s) 780 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 700 may include the graphics subsystem 760 and the output display 770. The output display 770 may include a cathode ray tube (CRT) display and/or a liquid crystal display (LCD). The graphics subsystem 760 receives textual and graphical information, and processes the information for output to the output display 770.

Each component of the computer 700 may represent a broad category of a computer component of a general and/or special purpose computer. Components of the computer 700 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures. Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing remote transactions, comprising:
at least one memory operable to store one or more sets of account data each set of account data including an account identifier; and
a processor coupled to the at least one memory, the processor being operable to:
receive a first request from a merchant system, the first request including a wallet identifier (WID);
retrieve, from the at least one memory, one or more sets of account data based on the WID;
transmit, to the merchant system, a first response including the one or more sets of account data retrieved from the at least one memory;
receive, from either the merchant system or an acquirer system, an authorization request including an account identifier corresponding to one of the one or more sets of account data retrieved from the at least one memory;
transmit, to an issuer system, a transaction data request including the account identifier;
receive, from the issuer system, a transaction data response including transaction data; and
transmit, to the merchant system or the acquirer system, the transaction data.

2. The system of claim 1, wherein the authorization request is received from the acquirer system and includes an encryption key.

3. The system of claim 2, wherein at least a portion of the transaction data response is encrypted using the encryption key.

4. The system of claim 1, wherein the transaction data includes one or more of (1) an account number and (2) an account verification code, corresponding to the account identifier.

5. The system of claim 1, wherein the processor is further operable to:
determine the one or more sets of account data corresponding to the WID during the retrieving the one or more sets of account data.

6. The system of claim 1, wherein the processor is further operable to:
transmit, to a mobile device corresponding to the WID, a pre-authorization request; and
receive, from the mobile device, a pre-authorization response including information indicating whether a remote transaction is approved or denied,
wherein the pre-authorization request includes information corresponding to a remote transaction.

7. The system of claim 1, wherein the processor is further operable to:
receive, from the merchant system, a request for contact information, the request for contact information including the WID;
retrieve, from the at least one memory, contact information associated with the WID; and
transmit, to the merchant system, the retrieved contact information associated with the WID.

8. The system of claim 1, wherein the process is further operable to:
receive a transaction receipt from the merchant system, the transaction receipt including the WID;
retrieve, from the at least one memory, contact information associated with the WID; and
transmit, to a messaging system associated with the retrieved contact information, the transaction receipt.

9. A system for managing remote transactions, comprising:
at least one memory operable to store one or more sets of account data including a corresponding account identifier; and
a processor coupled to the at least one memory, the processor being operable to:
receive a first request from a merchant system, the first request including a wallet identifier (WID);
retrieve, from the at least one memory, one or more sets of account data based on the WID;
transmit, to the merchant system, a first response including the one or more sets of account data retrieved from the at least one memory;
receive, from the merchant system or an acquirer system, an authorization request including an account identifier corresponding to one of the one or more sets of account data retrieved from the at least one memory;
retrieve, from the at least one memory, payment applet data corresponding to the account identifier;
transmit, to a mobile device corresponding to the WID, a transaction data request including the account identifier, and the payment applet data;
receive, from the mobile device, a transaction data response including transaction data; and
transmit, to the merchant system or the acquirer system, the transaction data.

10. The system of claim 9, wherein the transaction data request is transmitted to a secure element on the mobile device, the secure element including one or more payment applets.

11. A method for managing remote transactions, comprising steps of:
receiving a first request from a merchant system, the first request including a wallet identifier (WID);
retrieving, from at least one memory, one or more sets of account data based on the WID;
transmitting, to the merchant system, a first response including the one or more sets of account data retrieved from the at least one memory;
receiving, from either the merchant system or an acquirer system, an authorization request including an account identifier corresponding to one of the one or more sets of account data retrieved from the at least one memory;
transmitting, to an issuer system, a transaction data request including the account identifier;
receiving, from the issuer system, a transaction data response including transaction data; and
transmitting, to the merchant system or the acquirer system, the transaction data,
wherein each of the one or more sets of account data includes an account identifier.

12. The method of claim 11, wherein the authorization request is received from the acquirer system and includes an encryption key.

13. The method of claim 12, wherein at least a portion of the transaction data response is encrypted using the encryption key.

14. The method of claim 11, wherein the transaction data includes one or more of (1) an account number and (2) a verification code, corresponding to the account identifier.

15. The method of claim 11, further comprising steps of:
determining the one or more sets of account data corresponding to the WID during the retrieving the one or more sets of account data.

16. The method of claim 11, further comprising steps of:
transmitting, to a mobile device corresponding to the WID, a pre-authorization request; and
receiving, from the mobile device, a pre-authorization response including information indicating whether a remote transaction is approved or denied,
wherein the pre-authorization request includes information corresponding to a remote transaction.

17. The system of claim 11, further comprising steps of:
receiving, from the merchant system, a request for contact information, the request for contact information including the WID;
retrieving, from the at least one memory, contact information associated with the WID; and
transmitting, to the merchant system, the retrieved contact information associated with the WID.

18. The system of claim 11, further comprising steps of:
receiving a transaction receipt from the merchant system, the transaction receipt including the WID;
retrieving, from the at least one memory, contact information associated with the WID; and
transmitting, to a messaging system associated with the retrieved contact information, the transaction receipt.

19. A method for managing remote transactions, comprising steps of:
receiving a first request from a merchant system, the first request including a wallet identifier (WID);
retrieving, from at least one memory, one or more sets of account data based on the WID;
transmitting, to the merchant system, a first response including the one or more sets of account data retrieved from the at least one memory;
receiving, from the merchant system or an acquirer system, an authorization request including an account identifier corresponding to one of the one or more sets of account data retrieved from the at least one memory;
retrieving, from the at least one memory, payment applet data corresponding to the account identifier;
transmitting, to a mobile device corresponding to the WID, a transaction data request including the account identifier, and the payment applet data;
receiving, from the mobile device, a transaction data response including transaction data; and
transmitting, to the merchant system or the acquirer system, the transaction data,
wherein each of the one or more sets of account data includes an account identifier.

20. The method of claim 19, wherein the transaction data request is transmitted to a secure element on the mobile device, the secure element including one or more payment applets.

21. A non-transitory computer-readable medium having stored thereon sequences of instructions for causing one or more processors to:
receive a first request from a merchant system, the first request including a wallet identifier (WID);
retrieve, from at least one memory, one or more sets of account data based on the WID;
transmit, to the merchant system, a first response including the one or more sets of account data retrieved from the at least one memory;
receive, from either the merchant system or an acquirer system, an authorization request including an account identifier corresponding to one of the one or more sets of account data retrieved from the at least one memory;
transmit, to an issuer system, a transaction data request including the account identifier;
receive, from the issuer system, a transaction data response including transaction data; and
transmit, to the merchant system or the acquirer system, the transaction data,
wherein each of the one or more sets of account data includes an account identifier.

22. The computer-readable medium of claim 21, wherein the authorization request is received from the acquirer system and includes an encryption key.

23. The computer-readable medium of claim 22, wherein at least a portion of the transaction data response is encrypted using the encryption key.

24. The computer-readable medium of claim 21, wherein the transaction data includes one or more of (1) an account number and (2) a verification code, corresponding to the account identifier.

25. The computer-readable medium of claim 21, wherein the sequences of instructions further cause the one or more processors to:
determine the one or more sets of account data corresponding to the WID during the retrieving the one or more sets of account data.

26. The computer-readable medium of claim 21, wherein the sequences of instructions further cause the one or more processors to:
transmit, to a mobile device corresponding to the WID, a pre-authorization request; and
receive, from the mobile device, a pre-authorization response including information indicating whether a remote transaction is approved or denied,
wherein the pre-authorization request includes information corresponding to a remote transaction.

27. The computer-readable medium of claim 21, wherein the sequences of instructions further cause the one or more processors to:
receive, from the merchant system, a request for contact information, the request for contact information including the WID;
retrieve, from the at least one memory, contact information associated with the WID; and
transmit, to the merchant system, the retrieved contact information associated with the WID.

28. The computer-readable medium of claim 21, wherein the sequences of instructions further cause the one or more processors to:
receive a transaction receipt from the merchant system, the transaction receipt including the WID;
retrieve, from the at least one memory, contact information associated with the WID; and
transmit, to a messaging system associated with the retrieved contact information, the transaction receipt.

29. A non-transitory computer-readable medium having stored thereon sequences of instructions for causing one or more processors to:
receive a first request from a merchant system, the first request including a wallet identifier (WID);
retrieve, from the at least one memory, one or more sets of account data based on the WID;
transmit, to the merchant system, a first response including the one or more sets of account data retrieved from the at least one memory;
receive, from the merchant system or an acquirer system, an authorization request including an account identifier corresponding to one of the one or more sets of account data retrieved from the at least one memory;
retrieve, from the at least one memory, payment applet data corresponding to the account identifier;
transmit, to a mobile device corresponding to the WID, a transaction data request including the account identifier, and the payment applet data;
receive, from the mobile device, a transaction data response including transaction data; and
transmit, to the merchant system or the acquirer system, the transaction data,
wherein each of the one or more sets of account data includes an account identifier.

30. The computer-readable medium of claim 29, wherein the transaction data request is transmitted to a secure element on the mobile device, the secure element including one or more payment applets.
